(19) United States
(12) Patent Application Publication
(10) Pub. No.: US 2010/0031049 A1
(43) Pub. Date: Feb. 4, 2010

(54) TIME INFORMATION DISTRIBUTION SYSTEM, TIME DISTRIBUTING STATION, TERMINAL, TIME INFORMATION DISTRIBUTION METHOD, AND PROGRAM

(75) Inventors: Shigeyoshi Shima, Tokyo (JP); Yukiko Endo, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 12/450,368

(22) PCT Filed: Jan. 22, 2008
(86) PCT No.: PCT/JP2008/050745

§ 371 Date: Sep. 23, 2009

(30) Foreign Application Priority Data
Mar. 28, 2007 (JP) 2007-084570

(51) Int. Cl. H04L 9/32

(52) U.S. Cl. 713/176

(57) ABSTRACT

In a time information distribution system for distributing time information from a time distributing station to terminals, the time distributing station gives the electronic signature of the time distributing station to time information to be distributed and distributes the time information to which the electronic signature has been appended to the terminals. The terminals verify the electronic signature given to the time information distributed from the time distributing station and, if a determination has been made that the electronic signature has already been given by the time distributing station, store the time information to which the electronic signature is given in a hardware security module installed in the terminals.

### TECHNICAL FIELD

The present invention relates to a time information distribution system for distributing time information among devices, a time distributing station, a terminal, a time information distribution method, and a program.

### BACKGROUND ART

Conventionally, time information distributed from a time distributing station (TA: Time Authority) or a time distribution server is received by user terminals, and the received time information is used by applications which run on the user terminals.

This time information, for example, is added to transmitted electronic mail as a transmission date and time or is added to a received electronic mail as a reception date and time, when it is used by an electronic mail application. Also, the time information is added to a created document file as a creation date and time or as an update date and time of the document file.

In another technique contemplated in the art, the time of a system clock contained in a user terminal is synchronized with a standard time distributed from a server installed in a time distribution center in order to monitor the system clock and the time of a time count within the user terminal within a period in which the accuracy of the standard time is guaranteed (see, for example, JP-2002-229869A).

However, there is a problem in that the time distributed from the time distribution server to user terminals is susceptible to tampering by a user through manipulations on his user terminal. This can lead to a problem of tampered creation date and time and a tampered update date and time of a document file, or even a tampered transmission/reception date and time of electronic mail, so that the time information added to each will lose reliability.

Also, even if fraudulent time information is distributed to user terminals which utilize the time information from the time distribution server, a problem arises in that the user terminals cannot recognize that the distributed time information is fraudulent.

Also, in the technique described in JP-2002-229869A, since the synchronization process is performed in the user terminal, this process is complicated and can adversely affect operations of the system. Also, if time management software is uninstalled, a problem arises in that a user can tamper with the system time as a consequence.

### DISCLOSURE OF THE INVENTION

To solve the problems mentioned above, it is an object of the present invention to provide a time information distribution system, a time distributing station, a terminal, a time information distribution method, and a program which are capable of preventing time information from being tampered with, and of readily confirming that distributed time information is correct.

To achieve the above object, the present invention provides a time information distribution system for distributing time information from a time distributing station to a terminal, wherein:

the time distributing station gives an electronic signature of the time distributing station to time information to be distributed, and distributes the time information appended with the electronic signature to the terminal, and

the terminal verifies the electronic signature appended to the time information distributed from the time distributing station, and stores the time information appended with the electronic signature in a hardware security module uniquely installed in the terminal when it has been determined that the electronic signature was provided in the time distributing station.

The present invention also provides a time distributing station for distributing time information appended with an electronic signature to a terminal, wherein:

the time distributing station stores an encryption key for encrypting the time information in a hardware security module uniquely installed in the time distributing station, encrypts the time information using the stored encryption key, and distributes the encrypted time information to the terminal.

The present invention also provides a terminal for acquiring time information appended with an electronic signature and distributed from a time distributing station, wherein:

the terminal verifies the electronic signature, and stores the time information appended with the electronic signature in a hardware security module uniquely installed in the terminal when it has been determined that the electronic signature was provided in the time distributing station.

The present invention also provides a time information distribution method for distributing time information from a time distributing station to a terminal, the method comprising:

processing performed by the time distributing station for giving an electronic signature of the time distributing station to time information that is to be distributed;

processing performed by the time distributing station for distributing time information appended with the electronic signature to the terminal;

processing performed by the terminal for verifying the electronic signature appended to the time information distributed from the time distributing station; and

processing performed by the terminal for storing the time information appended with the electronic signature in a hardware security module uniquely installed in the terminal when it has been determined that the electronic signature was provided in the time distributing station.

The present invention also provides a program for providing time information distributed from a time distributing station to an application which runs on a terminal, the program causing a computer to execute:

a procedure for verifying an electronic signature appended to time information distributed from the time distributing station and

a procedure for storing the time information appended with the electronic signature in a hardware security module uniquely installed in the terminal when it has been determined that the electronic signature was provided in the time distributing station.

As described above, in the present invention, the time information appended with the electronic signature is distributed from the time distributing station to the terminal. The terminal verifies the electronic signature appended to the time information distributed from the time distributing station, and stores the time information appended with the electronic signature in the hardware security module uniquely installed in the terminal when it has been determined that the electronic signature was provided in the time distributing station. Accordingly, the time information can be prevented from being tampered with, and a confirmation can be readily made that the distributed time information is correct.

### BRIEF DESCRIPTION OF THE DRAWINGS

FIG. 1 A diagram showing one embodiment of a time information distribution system according to the present invention.

FIG. 2 A diagram showing an exemplary configuration of a time distributing station shown in FIG. 1.

FIG. 3 A diagram showing an exemplary configuration of a user terminal shown in FIG. 1.

FIG. 4 A sequence diagram for describing a process through which the time distributing station shown in FIG. 1 distributes time information to a user terminal.

FIG. 5 A sequence diagram for describing a process when client software does not rewrite time information registered in a user terminal after the registered time information has been requested by an application.

FIG. 6 A sequence diagram for describing a process when client software rewrites time information registered in a user terminal after the registered time information has been requested by an application.

### BEST MODE FOR CARRYING OUT THE INVENTION

In the following, an embodiment of the present invention will be described with reference to the drawings.

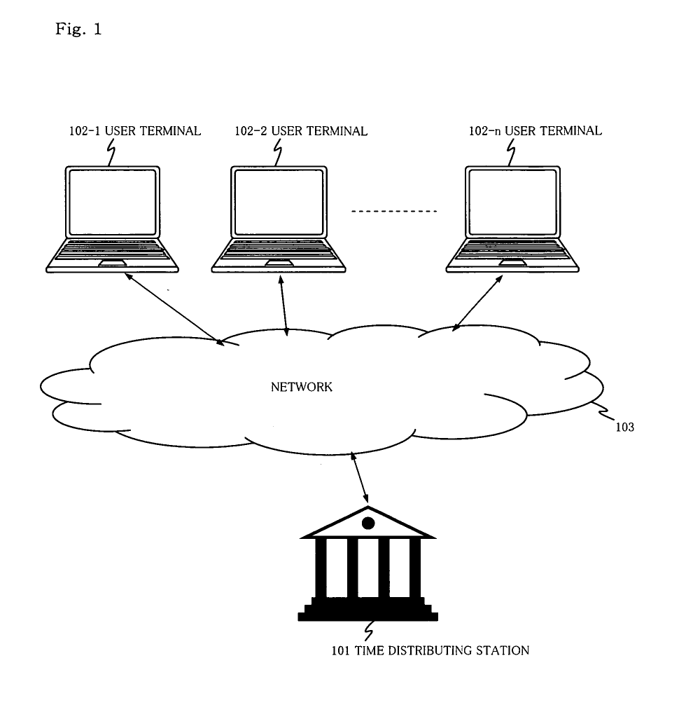

FIG. 1 is a diagram showing one embodiment of a time information distribution system according to the present invention.

As shown in FIG. 1, in this embodiment, time distributing station 101 is connected to user terminals 102-1-102-n, respectively, through network 103.

Time distributing station 101 is an information distributing station for distributing time information to user terminals 102-1-102-n through network 103.

User terminals 102-1-102-n are terminals which acquire the time information distributed from time distributing station 101 through network 103, and utilize the acquired time information.

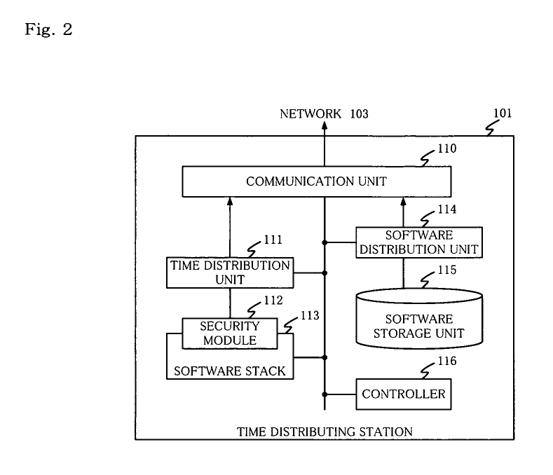

FIG. 2 is a diagram showing an exemplary configuration of time distributing station 101 shown in FIG. 1. As can be seen, FIG. 2 shows only those components related to the present invention from among elements which make up time distributing station 101 shown in FIG. 1.

As shown in FIG. 2, time distributing station 101 shown in FIG. 1 is provided with communication unit 110, time distribution unit 111, security module 112, software stack 113, software distribution unit 114, software storage unit 115, and controller 116 for controlling these components.

Communication unit 110 makes communications with user terminals 102-1-102-n through network 103.

Time distribution unit 111 distributes time information encrypted by security module 112 to user terminals 102-1-102-n through communication unit 110.

Security module 112 stores an encryption key, and encrypts the time information using this encryption key.

Software stack 113 includes drivers, API's (Application Program Interface) and the like for operating security module 112.

Software storage unit 115 stores client software for adjusting the time (rewriting the time).

Software distribution unit 114 distributes the client software stored in software storage unit 115 to user terminals 102-1-102-n through communication unit 110.

Alternatively, security module 112 may not encrypt the time information, but instead, software distribution unit 114 may encrypt the distributed time information (give an electronic signature of time distributing station 101) when the time information is distributed from software distribution unit 114.

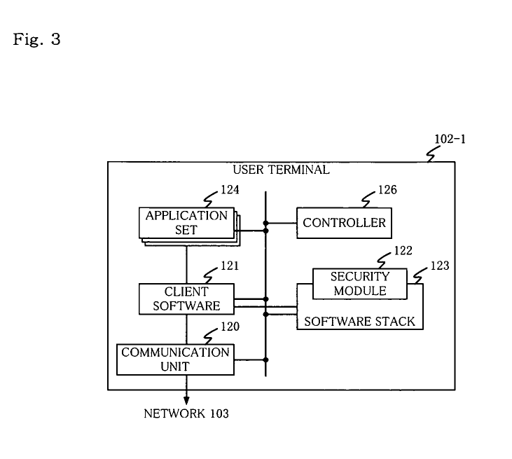

FIG. 3 is a diagram showing an exemplary configuration of user terminal 102-1 shown in FIG. 1. As can be seen, FIG. 2 shows only those components related to the present invention from among elements which make up user terminal 102-1 shown in FIG. 1. Also, components contained in user terminals 102-2-102-N are similar to the components contained in user terminal 102-1.

As shown in FIG. 3, user terminal 102-1 shown in FIG. 1 is provided with communication unit 120, client software 121, security module 122, software stack 123, application set 124, and controller 126 for controlling these components.

Communication unit 120 communicates with time distributing station 101 through network 103.

Security module 122 stores the time information distributed from the time distributing station, and a decryption key for decrypting the time information. Also, security module 122 rewrites the time information decrypted by software stack 123.

Software stack 123 includes drivers, API's (Application Program Interface) and the like for operating security module 122. Software stack 123 also performs platform attestation for client software 121. Based on the result of the platform attestation performed for client software 121, software stack 123 decrypts the time information stored in security module 122 with the decryption key stored in security module 122.

Client software 121 makes a request for rewriting the time information stored in security module 122 to the time information distributed from time distributing station 101, and provides application set 124 with the time information rewritten by security module 122.

Application set 124 is a collection of applications which utilize the time information provided from client software 121.

In this regard, security module 112 shown in FIG. 2, and security module 122 shown in FIG. 3 are modules for encrypting information. Here, security modules 112, 122 employ hardware security modules. The hardware security module refers to a security module which is uniquely installed in hardware of a general computer, and cannot be transported to another computer, for ensuring security and privacy. Also, the hardware security module is provided with a memory, and can store an encryption key, a decryption key, and the like in the memory. The keys stored in the hardware security module cannot be extracted from the outside. Also, when a hardware security module that is installed in a computer is removed from the computer, the computer is prevented from being activated. Accordingly, by storing an encryption key, a decryption key and the like of a user in a hardware security module, these keys and information encrypted by these keys can be ensured for security. A hardware security module is generally comprised of a combination of a chip and peripheral circuits thereof, and includes a TPM (Trusted Platform Module) by way of example.

In the following, a time information distribution method in the time information distribution system shown in FIGS. 1-3 will be described with reference to a sequence diagram. Here, an example will be given for the description, where time information is distributed from time distributing station 101 to user terminal 102-1. Also, when the time information is distributed from time distributing station 101 to user terminals 102-2-102-N, a process is performed in a similar manner to that described below.

First, a description will be given of a process through which time distributing station 101 shown in FIG. 1 distributes time information to user terminal 102-1.

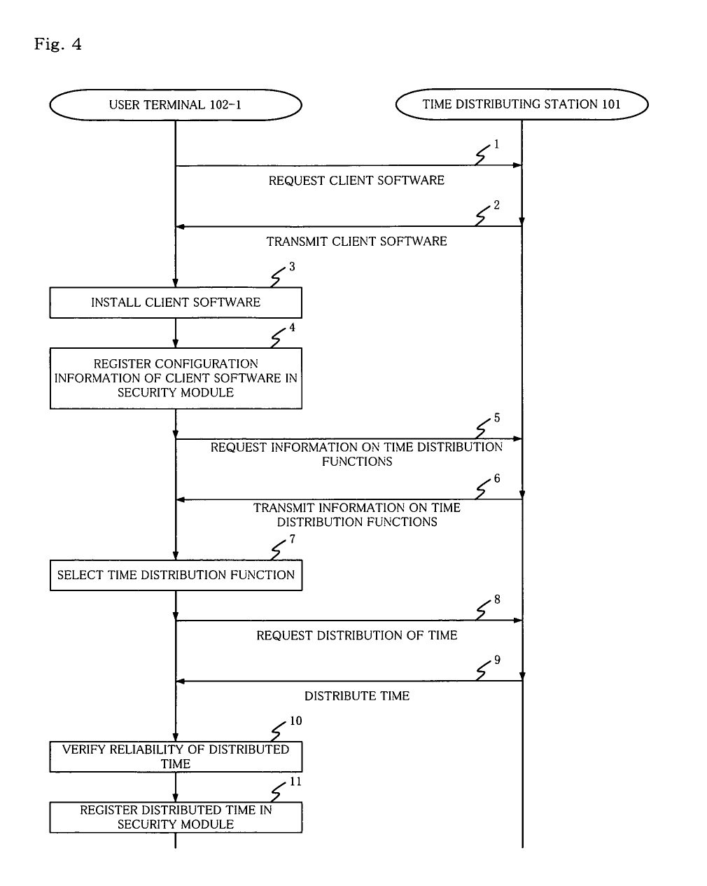

FIG. 4 is a sequence diagram for describing a process through which time distributing station 101 shown in FIG. 1 distributes time information to user terminal 102-1.

First, at step 1, since user terminal 102-1 makes a request to time distributing station 101 for client software, the client software stored in software storage unit 115 of time distributing station 101 is read by software distribution unit 114 and is transmitted from communication unit 110 to user terminal 102-1 through network 103 at step 2. Here, the request to time distributing station 101 for the client software from user terminal 102-1 may involve transmission/reception of any signal which allows for recognition of the request for the client software from user terminal 102-1 to time distributing station 101, where its signal format is not particularly defined herein. Also, no definition is particularly made herein for a transmission scheme for the client software transmitted from communication unit 110 of time distributing station 101 to user terminal 102-1.

Upon receipt of the client software transmitted from communication unit 110 of time distributing station 101 at communication unit 120 of user terminal 102-1, the received client software is installed in user terminal 102-1 at step 3. Then, configuration information on installed client software 121 is registered in security module 122 by controller 126 at step 4. Here, the configuration information refers to a series of digest values of software codes. This configuration information is registered in security module 122 for validating/verifying that client software 121 has a correct configuration.

Subsequently at step 5, user terminal 102-1 requests time distributing station 101 for information on a time distribution function through network 103.

When time distributing station 101 is requested for the information on the time distribution function from user terminal 102-1 through network 103, the information on the time distribution function is transmitted from time distribution unit 111 of time distributing station 101 to user terminal 102-1 through communication unit 110 at step 6.

Here, the request for the information on the time distribution function from user terminal 102-1 to time distributing station 101 may involve transmission/reception of any signal which allows for recognition of the request for the information on the time distribution function from user terminal 102-1 to time distributing station 101, where its signal format is not particularly defined herein. Also, no definition is particularly made herein for a transmission scheme for the information on the time distribution function transmitted from time distribution unit 111 of time distributing station 101 to user terminal 102-1 through communication unit 110. In this regard, the information on the time distribution function refers to information on a function of time distribution unit 111 of time distributing station 101, where a request from user terminal 102-1 to time distributing station 101 is arbitrary.

When there are a plurality of pieces of information on the time distribution functions transmitted from time distributing station 101, one time distribution function is selected from among them at step 7.

Then, at step 8, controller 126 of user terminal 102-1 makes a request for distribution of the time through communication unit 120 to time distributing station 101. Here, the request for the distribution of the time from controller 126 of user terminal 102-1 to time distributing station 101 through communication unit 120 may involve transmission/reception of any signal which allows for recognition of the request for the distribution of the time from controller 126 of user terminal 102-1 to time distributing station 101 through communication unit 120, where its signal format is not particularly defined herein.

When user terminal 102-1 makes a request to time distributing station 101 for the distribution of the time, a signature of time distributing station 101 is given to the time information using a secret key for the electronic signature, stored in security module 112, and the time information with the signature given thereto is distributed from time distribution unit 111 to user terminal 102-1 through communication unit 110 at step 9. Alternatively, the distributed time information may be given an electronic signature at software distribution unit 114, and the time information with the electronic signature given thereto may be distributed to user terminal 102-1. Additionally, a public key is distributed simultaneously for verifying the electronic signature. In this regard, for a signal format of the time information distributed from time distributing station 101 to user terminal 102-1, no definition is particularly made herein.

Since the time information is distributed from time distributing station 101 to user terminal 102-1, the reliability of the distributed time information is verified in security module 122 at step 10. Specifically, security module 122 verifies, using the public key distributed together with time information from time distributing station 101, whether or not the electronic signature appended to the time information has been given at time distributing station 101.

When the distributed time information is determined to be reliable as a result of the verification made at step 10, i.e., when the electronic signature appended to the distributed time information is determined to have been given at time distributing station 101, the time information is registered in security module 122 at step 11. This registration involves storing the time information in the memory provided in security module 122. Additionally, the time information may be encrypted by the encryption key of user terminal 102-1 before it is registered.

Next, processes in user terminal 102-1 will be described, as performed when the time information is requested by an application which runs on user terminal 102-1 after the time information has been registered as described above. First described is a process when client software 121 does not rewrite the time information registered in security module 122.

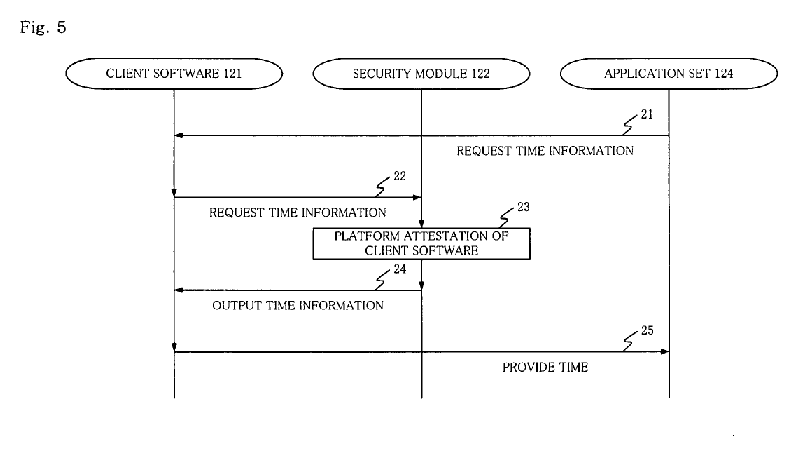

FIG. 5 is a sequence diagram for describing a process when client software 121 does not rewrite the time information registered in user terminal 102-1 after the registered time information has been requested by an application.

At step 21, when client software 121 is requested for the time information by at least one application of application set 124, security module 122 is requested for the time information from client software 121 at step 22. Here, as to a timing at which client software 121 is requested for the time information from the application of application set 124, the request is made at the time the time information is needed by the application. For example, when the application is a word processing application, the time information may be requested at a timing at which the application acquires the date and time at which a document is created or updated. When the application is an electronic mail application, the time information may be requested at a timing at which the application acquires the date and time at which an electronic mail is transmitted or received. Also, when the date and time are acquired at the time that an application is installed, the application can be managed for license. Further, as to the signals used for the requests at step 21 and step 22, any signals may be used as long as they allow for recognition of the requests for the time information, where their signal formats are not particularly defined herein.

When security module 122 is requested for the time information from client software 121, a platform attestation is performed for client software 121 in security module 122 at step 23. This platform attestation is provided to validate/verify that client software 121 has a correct configuration, i.e., is not tampered with by determining whether or not the configuration information previously registered in security module 122 matches current configuration information of client software 121, retrieved from client software 121 which has requested the time information.

When client software 121 is confirmed to have a correct configuration in security module 122, the time information stored in security module 122 is output to client software 121 at step 24. Here, when the time information stored in security module 122 is stored in an encrypted state, the time information is decrypted using the decryption key of user terminal 102-1 before it is output to client software 121.

When the time information is output from security module 122 to client software 121, the time information is provided from client software 121 to the application at step 25.

In this way, the requested time information is provided from reliable client software 121 to application set 124.

The process described above is applied to the time information in which the update frequency is in units of “days,” since client software 121 does not rewrite the time information registered in security module 122.

Next, a description will be given of a process when client software 121 rewrites the time information registered in security module 122.

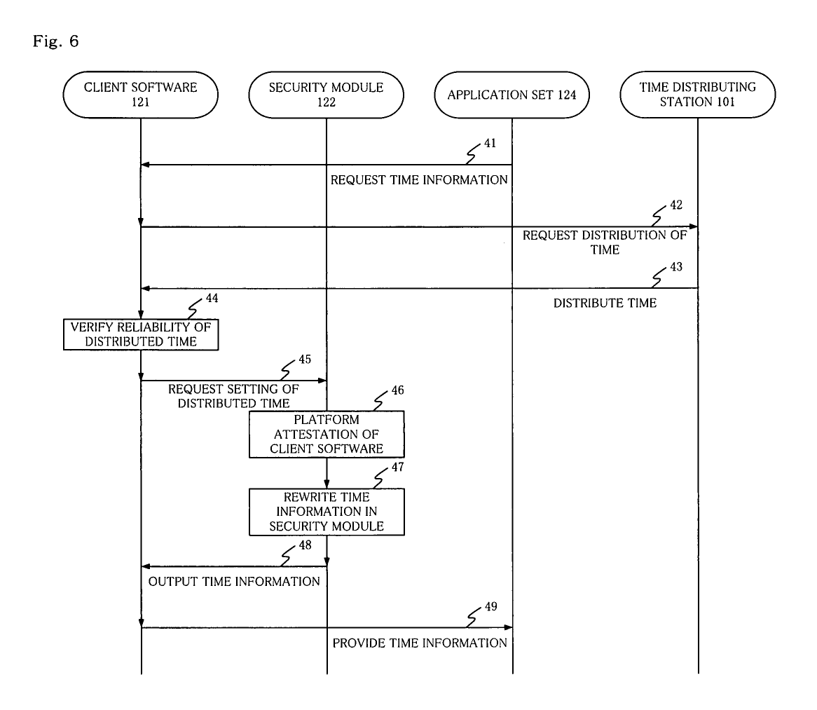

FIG. 6 is a sequence diagram for describing a process when client software 121 rewrites the time information registered in user terminal 102-1 after the registered time information has been requested by an application.

At step 41, when client software 121 is requested for the time information by least one application of application set 124, time distributing station 101 is requested for the time information from client software 121 at step 42. Here, as to a timing at which client software 121 is requested for the time information by the application of application set 124, the request is made at the time the time when information is required by the application. For example, when the application is a word processing application, the time information may be requested at a timing at which the application acquires the date and time at which a document is created or updated. When the application is an electronic mail application, the time information may be requested at a timing at which the application acquires the date and time at which an electronic mail is transmitted or received. Also, when the date and time are acquired at the time that an application is installed, the application can be managed for license. Further, as to the signals used for the requests at step 41 and step 42, any signals may be used as long as they allow for recognition of a request for the time information, where their signal formats are not particularly defined herein.

When time distributing station 101 is requested for the time information from client software 121, an electronic signature of time distributing station 101 is given to the time information using a secret key for the electronic signature, stored in security module 112 of time distributing station 101, and the time information with the electronic signature given thereto is distributed from time distribution unit 111 to client software 121 through communication unit 110 at step 43. Alternatively, the distributed time information may be given an electronic signature at software distribution unit 114 of time distributing station 101, and the time information with the electronic signature given thereto may be distributed to client software 121. Additionally, a public key is distributed simultaneously for verifying the electronic signature. In this regard, for a signal format of the time information distributed from time distributing station 101 to client software 121, no definition is particularly made herein.

As the time information is distributed from time distributing station 101 to client software 121, the reliability of the distributed time information is verified in security module 122 at step 44. Specifically, security module 122 verifies, using the public key distributed together with time information from time distributing station 101, whether or not the electronic signature appended to the time information has been given at time distributing station 101.

When the distributed time information is determined to be reliable as a result of the verification made at step 44, i.e., when the electronic signature appended to the distributed time information is determined to have been given at time distributing station 101, at step 45 client software 121 makes a request to security module 122 to set the distributed time information.

Since client software 121 has requested security module 122 to set the distributed time information, a platform attestation is performed for client software 121 in security module 122 at step 46. This platform attestation is provided to validate/verify that client software 121 has a correct configuration, i.e., is not tampered with by determining whether or not the configuration information previously registered in security module 122 matches current configuration information of client software 121, retrieved from client software 121 which has requested for the time information.

When client software 121 is confirmed to have a correct configuration in security module 122, the time information registered in security module 122 is rewritten at step 47 to the time information that has been distributed at step 43. Here, when the time information stored in security module 122 is stored in an encrypted state, the time information is decrypted by software stack 123 using the decryption key of user terminal 102-1 before it is rewritten to the distributed time information. Alternatively, the rewritten time information may be encrypted by the encryption key of user terminal 102-1. Also, in this event, it should be understood that the time information distributed at step 43 indicates a future time in advance to the time information registered in security module 122, and cannot therefore be rewritten to a past time previous to that. Here, if the time information is to be rewritten to a fraudulent time such as a past time, the time information registered in security module 122 may be erased.

When the time information registered in security module 122 is rewritten to the time information distributed at step 43, the rewritten time information is output from security module 122 to client software 121 at step 48.

When the time information is output from security module 122 to client software 121, the time information is provided from client software 121 to application set 124 at step 49.

In the process described above with reference to FIG. 6, since client software 121 rewrites the time information registered in security module 122, the time information is updated at a high level of frequency or updated a predetermined number of times, such as several times, a day after user terminal 102-1 has been activated.

Alternatively, instead of time distributing station 101, a time distribution server may be employed if it has a function for distributing time.

Additionally, in the present invention, a program for implementing the functions described above may be recorded on a computer readable recording medium, and the program recorded on the recording medium may be read into and executed by a computer. The computer readable recording medium refers to HDD contained in a computer, and the like, in addition to portable recording media such as a floppy disk (registered trademark), a magneto-optical disk, DVD, CD and the lie. The program recorded on the recording medium is read, for example, by controller 126 of user terminal 102-1 which is equivalent to a computer in the present invention, and processes similar to the foregoing are performed under the control of controller 126.

As described above, in the present invention, since the user cannot change the time in user terminal 102-1-102-n, it is possible to ensure the time utilized by applications which run on user terminal 102-1-102-n.

As described above, in a log acquisition system of the present invention, the terminal comprises the client software for requesting the hardware security module for time information stored in the hardware security module when a request is made to the terminal for the time information that will be used in an application which runs on the terminal, and provides the application with the time information output from the hardware security module, wherein the hardware security module acquires configuration information of the current client software when the time information is requested, and may output the time information stored in the hardware security module to the client software when the configuration information matches previously stored configuration information of the client software.

Also, the terminal comprises the client software which makes a request to the time distributing station for the time information when a request is made to the terminal for time information that will be used in an application which runs on the terminal, verifies an electronic signature appended to the time information distributed from the time distributing station, requests the hardware security module to rewrite time information stored in the hardware security module to the time information which is given the electronic signature when a determination is made that the electronic signature has already been given in the time distributing station, and provides the application with the time information output from the hardware security module, wherein the hardware security module may acquire configuration information of current client software when it is requested for a rewrite may, rewrite the time information stored in the hardware security module to the time information that has been given the electronic signature when the configuration information matches previously stored configuration information of the client software, and may output the time information to the client software.

Also, the time distributing station may encrypt the time information using an encryption key before it is transmitted to the terminal, while the terminal may decrypt the time information transmitted thereto from the time distributing station using a decryption key.

Also, the time distributing station may store the encryption key in a hardware security module which is uniquely installed in the time distributing station.

As well, the terminal may store the decryption key in a hardware security module which is uniquely installed in the terminal.

Also, the hardware security module installed uniquely in the terminal may be a TPM.

Furthermore, the hardware security module installed in the time distributing station may be a TPM.

Also, as described above, a time information distribution method of the present invention may comprise processing performed by client software installed in a terminal for requesting a hardware security module for time information stored in the hardware security module when a request is made for time information for use in an application which runs on the terminal; processing performed by the hardware security module for acquiring current configuration information of the client software when the time information is requested; processing performed by the hardware security module for outputting the time information stored in the hardware security module to the client software when the configuration information matches previously stored configuration information of the client software; and processing performed by the client software for providing the application with the time information output from the hardware security module.

The method may also comprise processing performed by client software installed in the terminal for requesting the time distributing station for time information when a request is made for time information for use in an application which runs on the terminal; processing performed by the client software for verifying an electronic signature appended to the time information distributed from the time distributing station; processing performed by the client software for requesting the hardware security module to rewrite time information stored in the hardware security module to the time information that has been given the electronic signature when a determination is made that the electronic signature has already been given in the time distributing station; processing performed by the hardware security module for acquiring current configuration information of the client software when it is requested for a rewrite; processing performed by the hardware security module for rewriting the time information stored in the hardware security module to the time information that has been given the electronic signature when the configuration information matches previously stored configuration information of the client software, and outputting the time information to the client software; and processing performed by the client software for providing the application with the time information output from the hardware security module.

The method may further comprise processing performed by the time distributing station for encrypting the time information using an encryption key; processing performed by the time distributing station for transmitting the encrypted time information to the terminal; and processing performed by the terminal for decrypting the time information transmitted thereto from the time distributing station using a decryption key.

Also, as described above, a program of the present invention may cause a computer to perform a procedure through which client software installed in a terminal makes a request to a hardware security module for time information stored in the hardware security module when the time information is requested by an application which runs on the terminal; a procedure through which the hardware security module acquires current configuration information of the client software when the time information is requested; a procedure through which the hardware security module outputs the time information stored in the hardware security module to the client software when the configuration information matches previously stored configuration information of the client software; and a procedure through which the client software provides the application with the time information output from the hardware security module.

The program may also cause the computer to perform a procedure through which client software installed in the terminal requests the time distributing station for time information when the time information is requested by an application which runs on the terminal; a procedure through which the client software verifies an electronic signature appended to the time information distributed from the time distributing station; a procedure through which the client software requests the hardware security module to rewrite time information stored in the hardware security module to the time information that has been given the electronic signature when a determination is made that the electronic signature has already been given in the time distributing station; a procedure through which the hardware security module acquires current configuration information of the client software when a request is made for a rewrite; a procedure through which the hardware security module rewrites the time information stored in the hardware security module to the time information that has been given the electronic signature when the configuration information matches previously stored configuration information of the client software, and outputs the time information to the client software; and a procedure through which the client software provides the application with the time information output from the hardware security module.

While the present invention has been described above with reference to some embodiments, the present invention is not limited to the embodiments described above. The present invention can be modified in configuration and details in various manners which can be understood by those skilled in the art within the scope of the present invention.

This application claims the priority based on Japanese Patent Application No. 2007-084570 filed Mar. 28, 2007, the disclosure of which is incorporated herein by reference in its entirety.

1-23. (canceled)

24. A terminal for acquiring time information distributed with an electronic signature appended thereto, wherein:
said terminal stores the time information in a hardware security module uniquely installed in said terminal,
said terminal comprises client software for making a request to said hardware security module for time information stored in said hardware security module when the time information is requested by an application which runs on said terminal, and for providing the application with the time information output from said hardware security module, and
said hardware security module acquires current configuration information of said client software, and outputs the time information stored in said hardware security module to said client software when the acquired configuration information matches previously stored configuration information of said client software.

25. A terminal for acquiring time information distributed with an electronic signature appended thereto, wherein:
said terminal stores the time information in a hardware security module uniquely installed in said terminal,
said terminal comprises client software for making a request to a distributor which has distributed the time information for the time information when the time information is requested by an application which runs on said terminal, verifying the electronic signature appended to the time information distributed from said distributor, requesting said hardware security module to rewrite time information stored in said hardware security module to the time information appended with the electronic signature when a determination is made that the electronic signature has already been given in said distributor, and providing the application with the time information output from said hardware security module, and
said hardware security module acquires current configuration information of said client software when said hardware security module is requested for the rewrite, rewrites the time information stored in said hardware security module to the time information appended with the electronic signature when the acquired configuration information matches previously stored configuration information of said client software, and outputs the time information to said client software.

26. The terminal according to claim 24, wherein said terminal decrypts the distributed time information using a decryption key.

27. The terminal according to claim 26, wherein said decryption key is stored in said hardware security module.

28. The terminal according to claim 24, wherein said hardware security module is a TPM.

29. A time information distribution method for distributing time information to a terminal, said method comprising:
processing for storing the time information in a hardware security module uniquely installed in said terminal;
processing performed by client software installed in said terminal for requesting said hardware security module for time information stored in said hardware security module when the time information is requested by an application which runs on said terminal;
processing performed by said hardware security module for acquiring current configuration information of said client software when the time information is requested;
processing performed by said hardware security module for outputting the time information stored in said hardware security module to said client software when the acquired configuration information matches previously stored configuration information of said client software; and
processing performed by said client software for providing the application with the time information output from said hardware security module.

30. A time information distribution method for distributing time information to a terminal, said method comprising:
processing for storing the time information in a hardware security module uniquely installed in said terminal;
processing performed by client software installed in said terminal for making a request to a distributor which has distributed the time information for the time information when the time information is requested by an application which runs on said terminal;
processing performed by said client software for verifying an electronic signature appended to the time information distributed from said distributor;
processing performed by said client software for making request to said hardware security module to rewrite time information stored in said hardware security module to the time information appended with the electronic signature when a determination is made that the electronic signature has already been given in said distributor;
processing performed by said hardware security module for acquiring current configuration information of said client software when said hardware security module is requested to perform the rewrite;
processing performed by said hardware security module for rewriting the time information stored in said hardware security module to the time information appended with the electronic signature, when the acquired configuration information matches the previously stored configuration information of said client software, and for outputting the time information to said client software; and
processing performed by said client software for providing the application with the time information output from said hardware security module.

31. The time information distribution method according to claim 29, further comprising:
processing performed by said terminal for decrypting the distributed time information using a decryption key.

32. A recording medium storing a program for providing distributed time information to an application which runs on a terminal, said program for causing a computer to execute:
a procedure for storing the time information in a hardware security module uniquely installed in said terminal;
a procedure through which client software installed in said terminal requests said hardware security module for time information stored in said hardware security module when the time information is requested by an application which runs on said terminal;
a procedure through which said hardware security module acquires current configuration information of said client software when the time information is requested;
a procedure for outputting the time information stored in said hardware security module from said hardware security module to said client software when the acquired configuration information matches the previously stored configuration information of said client software; and
a procedure through which said client software provides the application with the time information output from said hardware security module.

33. A recording medium storing a program for providing distributed time information to an application which runs on a terminal, said program for causing a computer to execute:
a procedure for storing the time information in a hardware security module uniquely installed in said terminal;
a procedure through which client software installed in said terminal requests a distributor which has distributed the time information for the time information when the time information is requested by an application which runs on said terminal;
a procedure through which said client software verifies an electronic signature appended to the time information distributed from said distributor;
a procedure through which said client software requests said hardware security module to rewrite time information stored in said hardware security module to the time information appended with the electronic signature, when a determination is made that the electronic signature has already been given in said distributor;
a procedure through which said hardware security module acquires current configuration information of said client software when said hardware security module is requested to perform the rewrite;
a procedure through which said hardware security module rewrites the time information stored in said hardware security module to the time information appended with the electronic signature when the acquired configuration information matches previously stored configuration information of said client software, and outputs the rewritten time information to said client software; and
a procedure through which said client software provides the application with the time information output from said hardware security module.

34. A terminal for receiving information appended with an electronic signature, verifying whether the information is valid based on the electronic signature, performing processing through the use of the information when the information is valid, receiving a request for information including configuration information of software of an information requester which requests the information from said information requester, verifying whether or not the information requester is valid based on the configuration information of the software, and transmitting information on the result of performing processing through the use of the information to said information requester when said information requester is valid.

35. The terminal according to claim 34, wherein said information is time information.

36. The terminal according to claim 35, wherein said information on the result is time information.

37. The terminal according to claim 34, wherein said terminal receives a plurality of pieces of information appended with the electronic signature, and transmits information on the result of performing the processing through the use of the latest one of the plurality of pieces of received information to said information requester.

38. The terminal according to claim 37, wherein said information is time information.

39. The terminal according to claim 38, wherein said information on the result is time information.

40. An information transmission method comprising receiving information appended with an electronic signature, verifying whether the information is valid based on the electronic signature, performing processing through the use of the information when the information is valid, receiving a request for information including configuration information of software of an information requester from said information requester, verifying whether or not the information requester is valid based on the configuration information of the software, and transmitting information on the result of performing processing through the use of the information to said information requester when said information requester is valid.

41. The information transmission method according to claim 40, wherein said information is time information.

42. The information transmission method according to claim 41, wherein said information on the result is time information

43. The information transmission method according to claim 40, further comprising:
receiving a plurality of pieces of information appended with the electronic signature, and transmitting information on the result of performing the processing based on the latest one of the plurality of pieces of received information to said information requester.

44. The information transmission method according to claim 43, wherein said information is time information.

45. The information transmission method according to claim 44, wherein said information on the result is time information.

46. The terminal according to claim 25, wherein said terminal decrypts the distributed time information using a decryption key.

47. The terminal according to claim 25, wherein said hardware security module is a TPM.

48. The time information distribution method according to claim 30, further comprising:
processing performed by said terminal for decrypting the distributed time information using a decryption key.
